(19) United States
(12) Patent Application Publication
(10) Pub. No.: US 2024/0160184 A1
(43) Pub. Date: May 16, 2024

(54) EMISSION CONTROL FOR AN OIL AND GAS PRODUCTION EQUIPMENT

(71) Applicant: Saudi Arabian Oil Company, Dhahran (SA)

(72) Inventors: Abdulaziz Ghamdi, Dammam (SA); Ahmer Irshad, Dhahran (SA); Anas H. Safar, Dhahran (SA); Mohammed A. Aljallal, Dammam (SA); Abdullmajeed I. Al Sanad, Dhahran (SA); Mohammed A. Almubayedh, Dhahran (SA); Ibrahim S. Alabbas, Dammam (SA); Turki A. Garni, Al Khobar (SA)

(21) Appl. No.: 17/982,831

(22) Filed: Nov. 8, 2022

(51) Int. Cl. G05B 19/4155

(52) U.S. Cl. CPC G05B 19/4155; G05B 2219/37371

(57) ABSTRACT

The present disclosure describes methods and systems, including computer-implemented methods, computer program products, and computer systems, for controlling emission of a hydrocarbon production. One computer-implemented method includes: determining, by one or more hardware processors, a flow rate of an emission source in a hydrocarbon production; determining, by the one or more hardware processors, a rate of formation of one or more emission components; determining, by the one or more hardware processors, a prediction indicator tag for the emission source; and outputting, by the one or more hardware processors, the prediction indicator tag in a user interface.

### TECHNICAL FIELD

This disclosure relates to a computer software program that interacts with oil and gas production equipment for emission control.

### BACKGROUND

In the oil and gas industry, production equipment such as power generators, boilers, cogeneration equipment assets, rotating equipment and others may become emission sources for greenhouse gas (GHG) and sulfuric dioxide (SO₂). Examples of the GHG include nitrogen dioxide (NO₂), carbon dioxide (CO₂), and methane (CH₄).

### SUMMARY

The present disclosure describes methods and systems, including computer-implemented methods, computer program products, and computer systems for monitoring and controlling emissions and adjusting production operations. One computer-implemented method includes: determining, by one or more hardware processors, a flow rate of an emission source in a hydrocarbon production; determining, by the one or more hardware processors, a rate of formation of one or more emission components; determining, by the one or more hardware processors, a prediction indicator tag for the emission source; and outputting, by the one or more hardware processors, the prediction indicator tag in a user interface.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that, in operation, cause the system to perform the actions. One or more computer programs can be configured to perform particular operations or actions by virtue of including instructions that, when executed by data processing apparatus, cause the apparatus to perform the actions.

The details of one or more implementations of the subject matter of this specification are set forth in the accompanying drawings and the subsequent description. Other features, aspects, and advantages of the subject matter will become apparent from the description, the drawings, and the claims.

### DESCRIPTION OF DRAWINGS

FIG. 1 is a flow diagram showing an example workflow for controlling emission by an emission control system, according to an implementation.

FIG. 2 is a screenshot showing an example of a user interface for displaying emission information, according to an implementation.

FIG. 3 is a screenshot showing an example of another user interface for displaying emission information, according to an implementation.

FIG. 4 illustrates an example method for emission control of an oil and gas production operation, according to an implementation.

FIG. 5 is a high-level architecture block diagram of a computer system based on the methods described in this disclosure, according to an implementation.

FIG. 6 is a screenshot showing an example of yet another user interface for displaying emission information, according to an implementation.

FIG. 7 is a screenshot showing an example of a user interface for displaying emission information by scope, according to an implementation.

Like reference numbers and designations in the various drawings indicate like elements.

### DETAILED DESCRIPTION

The following description is presented to enable any person skilled in the art to make and use the disclosed subject matter and is provided in the context of one or more particular implementations. Various modifications to the disclosed implementations will be readily apparent to those skilled in the art, and the general principles defined in this disclosure may be applied to other implementations and applications without departing from scope of the disclosure. Thus, the present disclosure is not intended to be limited to the described or illustrated implementations, but is to be accorded the widest scope consistent with the principles and features disclosed in this disclosure.

In the oil and gas (O&G) industry, production equipment in facilities, including oilfield or refinery, can be a source of GHG and SO₂ emissions. Examples of the emission sources include combustion sources connected to a fuel gas system. In some cases, real-time data of the emission source can be analyzed with the heat and material balance of the processing facilities, lab results and volumetric flowrate, to compute GHG and SO₂ emissions at the source level. The system can provide two layers of validation to enable operating facilities to affirm their emissions figures. The first layer of validation includes processing real-time data gathered from the facilities flow meters. The second layer of validation includes calculating for the flow of a stream based opening of the control valves that control the pressure or level for the flow. This approach enables the system to provide an accurate result while removing impact of outlier or misleading data. The system can output the result in a user interface to provide real-time monitoring of the emission. The system can also use the result to enable operations to reduce combustible fluids, improve the accuracy of emissions calculations for the emission level, establish emissions baseline, and identify intensive emission sources.

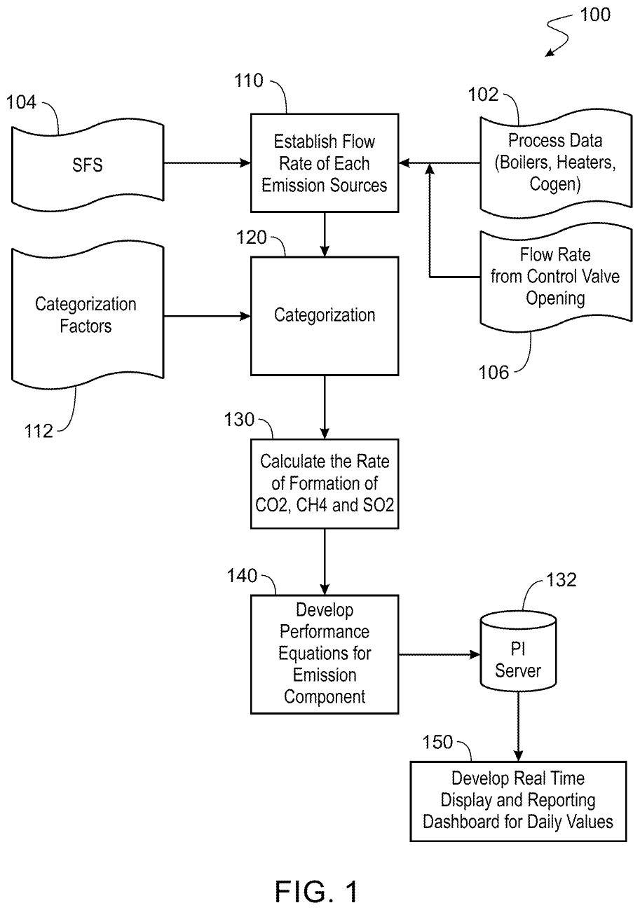

This disclosure describes a system that monitors, predicts and manages control the emission in hydrocarbon production. In some implementations, the emissions control system determines a flow rate of an emission source, a rate of formation of one or more emission components, and a prediction indicator tag for the emission source, the emission control system outputs the prediction indicator tag in a user interface and controls the production equipment according to the emission prediction. FIGS. 1-5 and associated descriptions provide additional details of these implementations.

Techniques described herein produce one or more technical effects. In some cases, the techniques can provide an automated tool to monitor the parameters of field production in the reservoir in real time and estimate the emission in real time. The techniques can further provide an interactive interface to monitor the emission of the production equipment. Moreover, the techniques can provide automatic control of production equipment and adjust production operations to reduce emission.

FIG. 1 is a flow diagram showing an example workflow 100 for controlling emission by an emission control system, according to an implementation. At 110, the flow rate of each emission source is established based on input from process data 102, flow rate from control valve opening 106, and volumetric flowrate and emissions calculation from smart flare solution (SFS) 104. The process data 102 are obtained for each emission source. Examples of the emission sources include boilers, heaters, furnaces, turbines, flanges, seals, electricity utilities, and other equipment that may generate emissions in an oil and gas production field. In some cases, the emission sources can include equipment connected to the fuel gas system. In some cases, the process data 102 can be obtained in real-time from sensors that are installed on the equipment. Examples of the process data 102 include temperature and pressure data, control valves opening data, reliable online analysis data, and fuel gas flow rate. The volumetric flowrate and emissions calculations from smart flare solution (SFS) 104 include emissions from flare systems. The flow rate from control valve opening 106 is calculated based on the real-time pressure data and temperature data, as discussed below.

In some implementations, the flow rate of each emission source is established by comparing the real-time flow rate and the calculated flow rate of the emission source. A higher value between the two flow rates is selected as the established flow rate. This approach provides a conservative estimation of the emission by taking into consideration the maximum flow rate for the control valve.

At 120, the established flow rates are grouped into different levels by source, scope, asset, facility, department, admin area, and any combination thereof. The categorization is performed based on categorization factors 112 of the emission source. Examples of the categorization factors 112 include composition, emissions factors, and equipment efficiency. For example, the emission factors can include scope (for example, scope 1, 2, or 3), equipment type (for example boiler, turbine, heaters), name of the processing unit, plant, department (a department can include multiple plants), admin area (for example, oil producing), business line (for example, upstream or downstream).

At 130, the rate of formation is calculated based on combustion stoichiometric coefficients.

In some implementation, determining the flow rate of each emission component can include, for example, calculating the corresponding molar and mass flow for each component under a standard pressure and temperature value. In one example, the standard pressure is 14.7 pounds per square inch absolute (psia) and the standard temperature is 60 degrees Fahrenheit (° F.). The flow rate is also referred to the molar rate. In some cases, The American Petroleum Institute (API) Compendium emission methodology (for example, API, Compendium of Green Gas methodologies for Oil and Natural Gas Industry, 2009) can be used. Equation 1 provides an example of calculating the molar rate Ecol:

$${E}_{CO 2} = Volume Flared \times Molar Volume Conversion \times MW {CO}_{2} \times mass coversion \times [ \sum ( \frac{Mole Hydrocarbon}{mole gas} \times \frac{A mole C}{mole Hydrocarbon} \times \frac{S mole {CO}_{2}}{mole C consumed} ) + \frac{B Mole {CO}_{2}}{mole gas} ] \qquad ( 1 )$$

where: Molar Volume Conversion is a conversion from molar volume to mass, for example, at a rate of 379.3 standard cubic feet per pound-mole (scf/lb-mol) or a conversion of 23.685 cubic meters per kilogram-mole (m³/kg-mole); MW CO₂ is a CO₂ molecular weight; mass conversion is, for example, tons/2204.621b or tons/1000 kg; A is a number of moles of carbon for a particular hydrocarbon; and B is a number of moles of CO₂ present in the flared gas stream. Mass conversion represents the conversion of two different mass units, for example, from pound (lb) to kilograms (kg) or from tons to lb. Volume flare represents volume of emissions that are routed to the flare. S represents combustion efficiency for each combustion source. Mole Hydrocarbon/mole gas represents ratio of hydrocarbon moles in the gas stream that attributes to emissions to the total number of moles of the gas stream (including non-hydrocarbon compounds such as Nitrogen)

The rate of formation calculations can be determined using the combustion stoichiometric coefficients for the formation of SO₂ and CO₂ with the following equation:

$${HC}_{i} + {a O}_{2} \to {b CO}_{2} + {c H}_{2} O \qquad ( 2 )$$

$${H}_{2} S + \frac{1}{2} {O}_{2} \to {SO}_{2} + {H}_{2} O \qquad ( 3 )$$

where: HC is a molar flow of component (i), for example, in pound-moles per day (lb-mol/d); a, b, and c are stoichiometric coefficients of combustion reaction (that are set based on the hydrocarbon component); O₂ is a molar rate of oxygen required for combustion, for example, in lb-mol/d; H₂S is a molar flow of hydrogen sulfide, for example, in lb-mol/d; CO₂ is a rate of formation of H₂S, for example, in lb-mol/d; and SO₂ is a rate of formation of SO₂, for example, in lb-mol/d. In the term HCᵢ, the component i represents a number of carbons in a given compound. For example, C₃H₆ has three carbon atoms, and thus will generate three times more CO₂ as compared to CH₄.

The American Petroleum Institute (API) Compendium emission methodology (for example, API, Compendium of Green Gas methodologies for Oil and Natural Gas Industry, 2009) can be used as follows:

$${E}_{CO 2} = Volume Flared \times Molar Volume Conversion \times MW {CO}_{2} \times mass conversion \times [ \sum ( \frac{Mole Hydrocarbon}{mole gas} \times \frac{A mole C}{mole Hydrocarbon} \times \frac{0.98 mole {CO}_{2}}{mole C consumed} ) + \frac{B Mole {CO}_{2}}{mole gas} ] \qquad ( 4 )$$

where: Molar Volume Conversion is a conversion from molar volume to mass, for example, at a rate of 379.3 standard cubic feet per pound-mole (scf/lb-mol) or a conversion of 23.685 cubic meters per kilogram-mole (m³/kg-mole); MW CO₂ is a CO₂ molecular weight; mass conversion is, for example, tons/2204.621b or tons/1000 kg; A is a number of moles of carbon for a particular hydrocarbon; and B is a number of moles of CO₂ present in the flared gas stream. Note that API Compendium recommends test data or vendor-specific information, such as flare combustion efficiency, for estimating flare emissions from gas streams. This is because this information is of higher quality than the default 98% combustion efficiency:

$${E}_{CH 4} = V \times {CH}_{4} Mole fraction \times \% residual {CH}_{4} \times \frac{1}{molar volume conversion} \times {MW}_{CH 4} \qquad ( 5 )$$

where: E_{CH4} is an amount of emissions of CH₄ (for example, in lb); V is a volume flared (for example, in scf); % residual CH₄ is a non-combusted fraction of flared stream (for example, with a default of 0.5% or 2%); molar volume conversion is a conversion from molar volume to mass, (for example, 379.3 scf/lb-mole or a conversion of 23.685 m³/kg-mole); and MW_{CH4} is a CH₄ molecular weight. Note that because the API Compendium indicates that flare systems have a combustion efficiency greater than 98%, the % residual CH₄ can be set at a default of 2% as a conservative measure. Then, based on Equation (4):

E_{N}_{₂}_{O}=V×EF_{N}_{₂}_{O} (6)

where: E_{N20} is an amount of emissions of N₂O; V is a volume produced or refined (m³, scf, or barrels (bbl)); and EF_{N2O} is an N₂O emission factor (for example, set to a value based on environmental protection data).

Based on the rate of formation of each component, the emission for the component over a configured duration, for example, 24 hours, can be determined by multiplying the rate by the duration of time. At 140, a performance equation (for example, equations 1-5 discussed previously) for each emission component is developed. The performance equation can be used to generate performance indicator (PI) tag. The PI tags can be stored on a server, for example, the PI server 132. In some implementations, the PI server 132 can be part of a PI system that provides operation insights, enabling digital transformation through trusted, high-quality operations data.

At 150, a real-time display and reporting dashboard for daily values is developed and outputted on a user interface of the emission control system. The PI Tags are used for the real-time display and reporting dashboard to illustrate and monitor emission control.

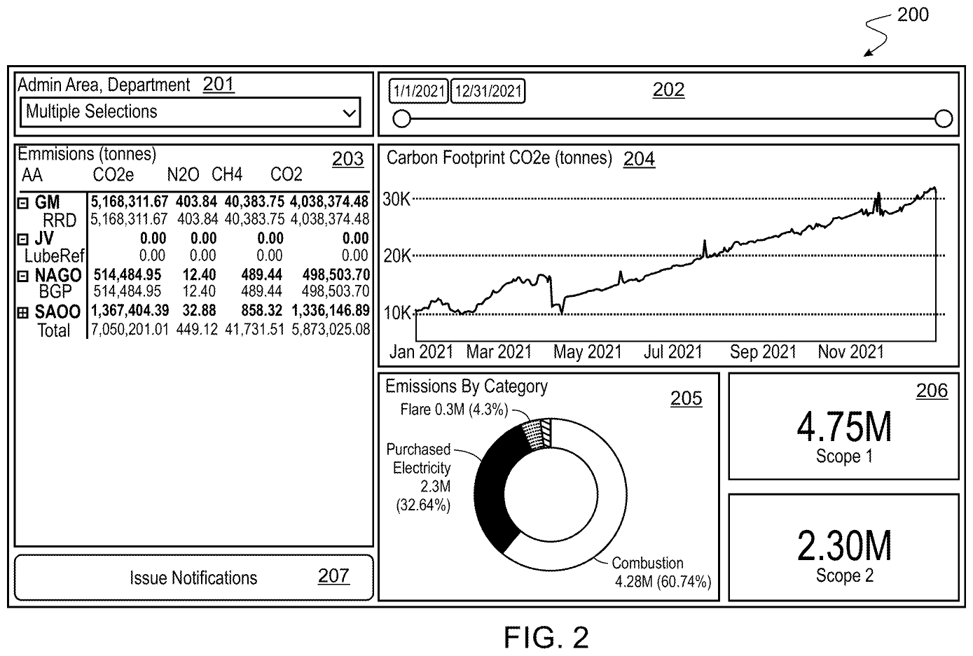

FIG. 2 is a screenshot showing an example of a user interface 200 for displaying emission information, according to an implementation. The user interface 200 includes a diagram that shows the CO₂ emission of each day in a selected time frame (one year was used for this example). As shown in the illustrated example, the user interface 200 includes 201 that represents a dropdown list. When selected, the dropdown list shows a list of operating facilities that a user may select to view the results. The user interface 200 includes 202 that represents a timeline. A user can select beginning and ending points on the timeline to indicate a particular time frame for displaying the results. The time frame can be one or more days, one or more weeks, or on an annual basis. The user interface 200 includes 203 that shows the cumulative values of emissions for the selected operating facilities and the selected time frame. The emissions include carbon dioxide with its equivalent such as Methane, Carbon Dioxide, nitrogen Oxide. The user interface 200 includes 204 that represents a graph. The graph demonstrates the daily trend of the carbon equivalent emissions for the selected operating facilities. The user interface 200 includes 205 that represents a chart. The chart illustrates the contribution of each emissions category. The chart can be color coded to distinguish between categories. The user interface 200 includes 206 that represents emissions of different scope, for example, Scope 1 that represents the direct combustion and process related emissions, and scope 2 that represents the power and utilities import.

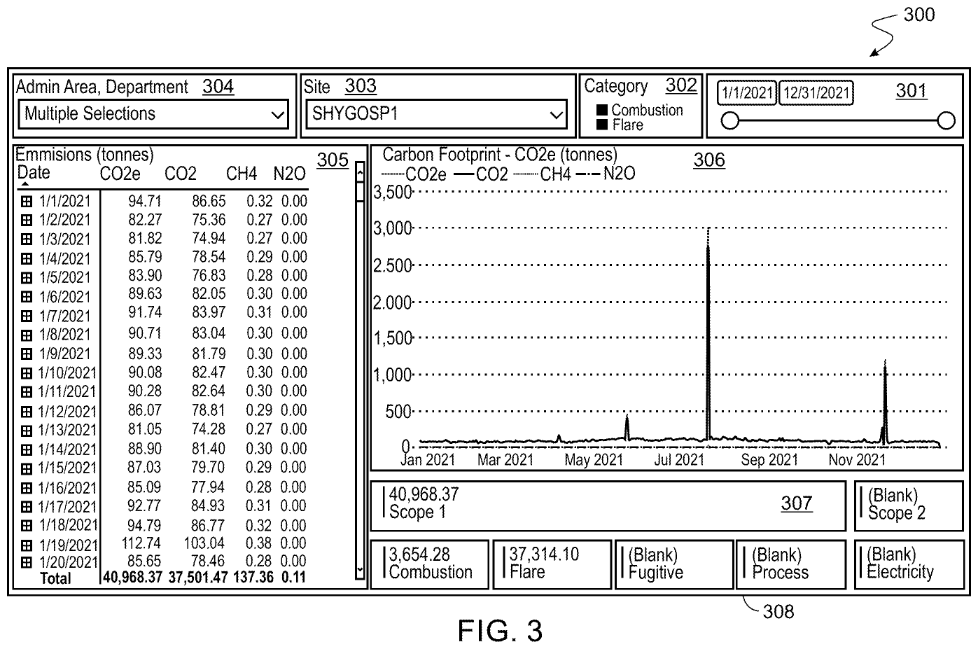

FIG. 3 is a screenshot showing an example of another user interface 300 for displaying emission information, according to an implementation. As shown in the illustrated example, the user interface 300 includes 301 that represents a timeline. A user can select beginning and ending points on the timeline to indicate a particular time frame for displaying the results. The user interface 300 includes 302 that indicates the category of the emissions. In this example, the emission is due to combustion or discharged through flare. The user interface 300 includes 304 that represents a dropdown list. When selected, the dropdown list shows a list of operating facilities that a user may select to view the results. The user interface 300 includes 303, which indicate that a site with ID SHYGOSP1 is selected. Each site is assigned a unique Site ID in the data base. The user interface 300 includes 305 that shows the cumulative values of emissions for the selected operating facilities,\ and time frame. The emissions include \ carbon dioxide with its equivalent such as Methane, Carbon Dioxide, nitrogen Oxide. The user interface 300 includes 306 that shows the daily trend of the carbon equivalent emissions for the selected operating facilities. The user interface 300 includes 307 that shows the emissions from each scope, including Scope 1 for the direct combustion and process related emissions and Scope 2 for the power and utilities import. The user interface 300 includes 308 that shows a breakdown of the emissions figures by emissions sources such as combustion, flare, fugitives, process and electricity.

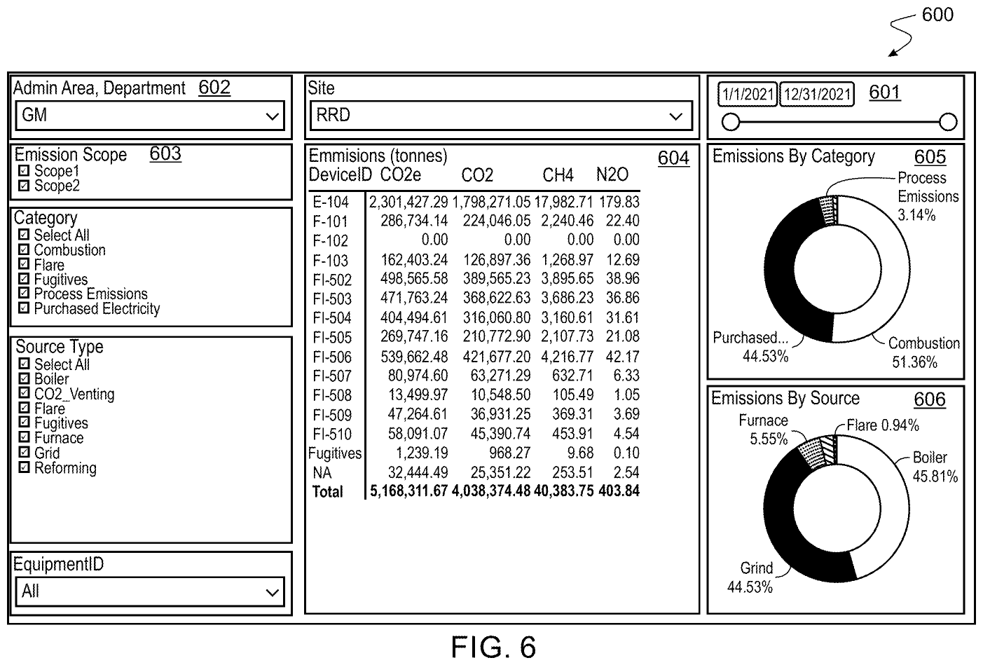

FIG. 6 is a screenshot showing an example of yet another user interface 600 for displaying emission information, according to an implementation. As shown in the illustrated example, the user interface 600 includes 601 that represents a timeline. A user can select beginning and ending points on the timeline to indicate a particular time frame for displaying the results. The user interface 600 includes 602 that represents a dropdown list. When selected, the dropdown list shows a list of operating facilities that a user may select to view the results. In this case, the department “GM” is selected. The user interface 600 includes 603 that shows the category of emissions that are selected, including emission, scope, categories of process that causes the emission, and categories of source types of the emissions. The user interface 600 includes 604 that shows the emissions figures from each device (for example, flow meters, calculated through CV opening) and include carbon dioxide with its equivalent such as Methane, Carbon Dioxide, nitrogen Oxide. The user interface 600 includes 605 that represents a chart. The chart illustrates the contribution of each emissions category. The chart can be color coded to distinguish between categories. The user interface 600 includes 606 that represents another chart, which that illustrates the contribution of each equipment source.

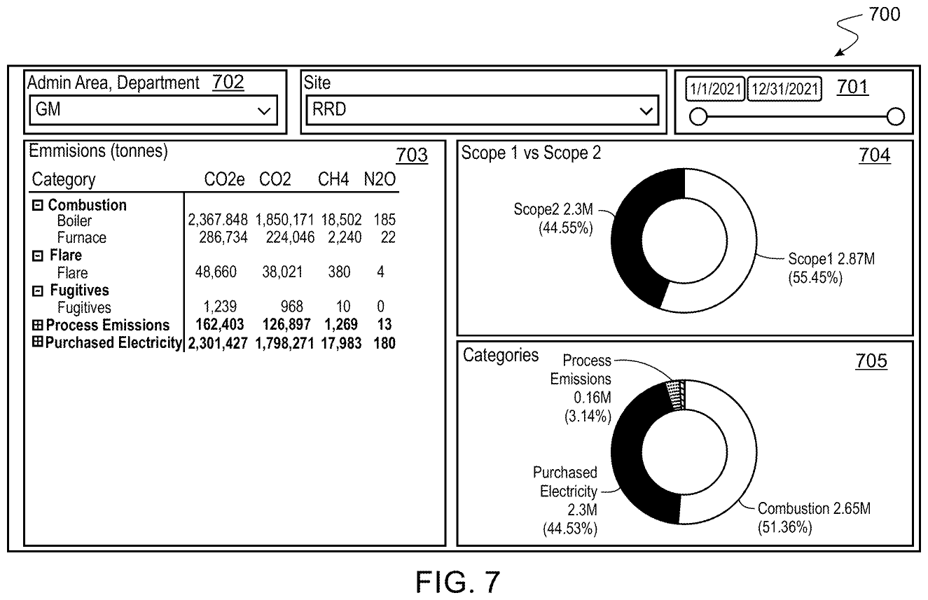

FIG. 7 is a screenshot showing an example of a user interface 700 for displaying emission information by scope, according to an implementation. The user interface 700 includes 701 that represents a timeline. A user can select beginning and ending points on the timeline to indicate a particular time frame for displaying the results. The user interface 700 includes 702 that represents a dropdown list. When selected, the dropdown list shows a list of operating facilities that a user may select to view the results. In this case, the department “GM” is selected. The user interface 700 includes 703 that shows the emission based on categories. The user interface 700 includes 704 that represent a chart. The chart 704 shows a comparison of emissions of different scope. The user interface 700 includes 705 that represent another chart. The chart 705 shows the contribution of each emissions category within each scope (for example: combustion, flare, fugitives, process emissions in Scope 1, and purchased electricity for Scope 2).

In some implementations, the emission control system can also perform automatic adjustments to the production equipment based on the emission data calculated by the emission control system, as discussed previously. For example, if the emission of one particular emission component or the combined emission exceeds a configured threshold over a configured duration, the emission control system can send commands to control valves, including, for example, the pressure control valves, flow control valves, or level control valves to adjust the operation and reduce emission. In another example, if the emission exceeds another configured level, the emission control system can send commands to the emergency shutdown system to shut down the production operation. For example, the emergency shutdown system can close the emergency valves (ZV) and stop the pumps and drilling rigs in a production well. The emergency shutdown system can also send commands to the venting, draining, and pressure relief valves to open these valves and stop the pressure build up.

Alternatively, or in combination, the emission control system can provide a user interface that receives inputs from the operator to make the adjustments as discussed previously. The user interface can provide real-time emission data to enable the operator to monitor the effect of these adjustments.

In addition, the emission control system can output alarms if the emission data exceeds a configured threshold. The alarms can include a visual alarm with different color codes corresponding to different levels of emission. The alarms can also include audio alarms with different volumes and patterns corresponding to different levels of emission.

Techniques of the present disclosure can be used to identify the emission levels of different emission sources. Emissions reporting can also be provided on a real-time basis, including identifying daily average values and automatically identifying reasons for the high-emission conditions and events. They can be used to enhance the emission monitoring quality and to further adjust the operation of an oil and gas production to mitigate, reduce, and eliminate GHG and SO₂ emissions.

In some implementations, in addition to (or in combination with) any previously described features, techniques of the present disclosure can include the following. Customized user interfaces can present intermediate or final results of the above-described processes to a user. The presented information can be presented in one or more textual, tabular, or graphical formats, such as through a dashboard. The information can be presented at one or more on-site locations (such as at an oil well or other facility), on the Internet (such as on a webpage), on a mobile application (or “app”), or at a central processing facility. The presented information can include suggestions, such as suggested changes in parameters or processing inputs, that the user can select to implement improvements in a production environment, such as in the exploration, production, and/or testing of petrochemical processes or facilities. For example, the suggestions can include parameters that, when selected by the user, can cause a change or an improvement in drilling parameters (including speed and direction) or overall production of a gas or oil well. The suggestions, when implemented by the user, can improve the speed and accuracy of calculations, streamline processes, improve models, and solve problems related to efficiency, performance, safety, reliability, costs, downtime, and the need for human interaction. In some implementations, the suggestions can be implemented in real-time, such as to provide an immediate or near-immediate change in operations or in a model. The term real-time can correspond, for example, to events that occur within a specified period of time, such as within one minute or within one second. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are located in different countries or other jurisdictions.

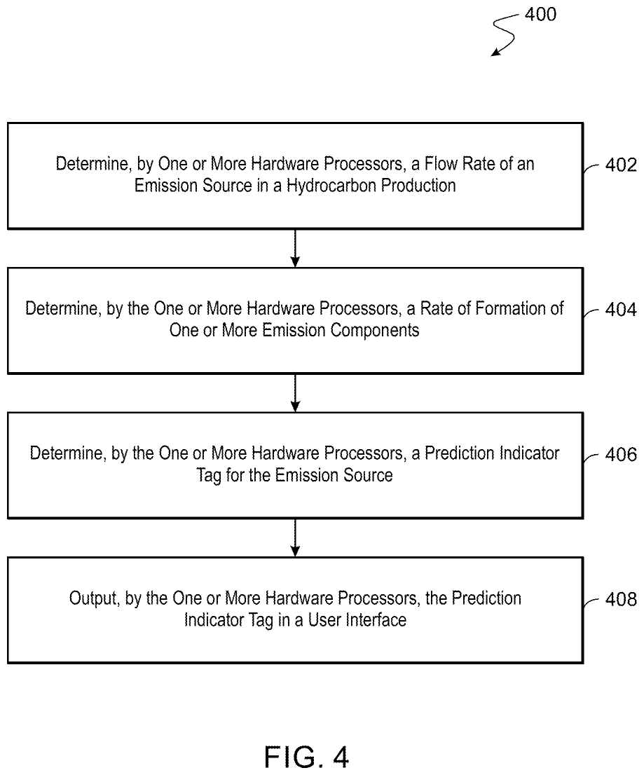

FIG. 4 illustrates an example method 400 for emission control of an oil and gas production operation, according to an implementation. For clarity of presentation, the description that follows generally describes method 400 in the context of FIGS. 1-3 and 5-7. In some implementations, various steps of the method 400 can be run in parallel, in combination, in loops, or in any order.

At 402, a flow rate of an emission source in a hydrocarbon production is determined. At 404, a rate of formation of one or more emission components is determined. At 406, a prediction indicator tag for the emission source is determined. At 408 the prediction indicator tag is outputted in a user interface.

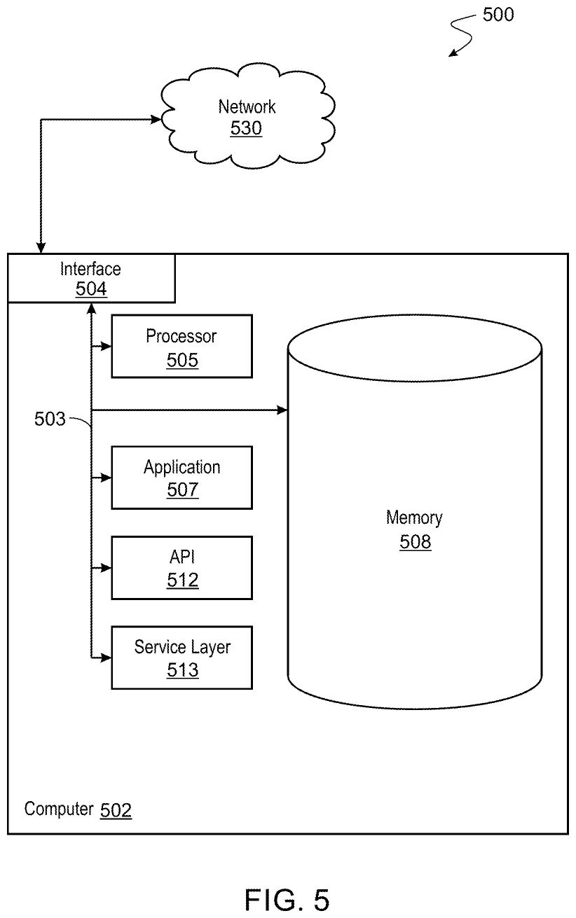

FIG. 5 is a high-level architecture block diagram of a computer system 500 based on the methods described in this disclosure, according to an implementation. At a high level, the illustrated system 500 includes a computer 502 coupled with a network 530. The system 500 can be used to implement the methods discussed previously in FIGS. 1-4.

The described illustration is only one possible implementation of the described subject matter and is not intended to limit the disclosure to the single described implementation. Those of ordinary skill in the art will appreciate the fact that the described components can be connected, combined, or used in alternative ways, consistent with this disclosure.

The network 530 facilitates communication between the computer 502 and other components, for example, components that obtain observed data for a location and transmit the observed data to the computer 502. The network 530 can be a wireless or a wireline network. The network 530 can also be a memory pipe, a hardware connection, or any internal or external communication paths between the components.

The computer 502 includes a computing system configured to perform the method as described in this disclosure. In some cases, the method can be implemented in an executable computing code, for example, C/C++ executable codes. In some cases, the computer 502 can include a standalone LINUX system that runs batch applications. In some cases, the computer 502 can include mobile or personal computers.

The computer 502 may comprise a computer that includes an input device, such as a keypad, keyboard, touch screen, microphone, speech recognition device, other devices that can accept user information, or an output device that conveys information associated with the operation of the computer 502, including digital data, visual or audio information, or a graphic user interface (GUI).

The computer 502 can serve as a client, network component, a server, a database, or other persistency, or any other component of the system 500. In some implementations, one or more components of the computer 502 may be configured to operate within a cloud-computing-based environment.

At a high level, the computer 502 is an electronic computing device operable to receive, transmit, process, store, or manage data and information associated with the system 500. According to some implementations, the computer 502 may also include, or be communicably coupled with, an application server, e-mail server, web server, caching server, streaming data server, business intelligence (BI) server, or other server.

The computer 502 can receive requests over network 530 from a client application (for example, executing on another computer 502) and respond to the received requests by processing said requests in an appropriate software application. In addition, requests may also be sent to the computer 502 from internal users (for example, from a command console), external or third parties, or other automated applications.

Each of the components of the computer 502 can communicate using a system bus 503. In some implementations, any or all the components of the computer 502, both hardware or software, may interface with each other or the interface 504, over the system bus 503, using an application programming interface (API) 512 or a service layer 513. The API 512 may include specifications for routines, data structures, and object classes. The API 512 may be either computer language-independent or -dependent and refer to a complete interface, a single function, or even a set of APIs. The service layer 513 provides software services to the computer 502 or the system 500. The functionality of the computer 502 may be accessible for all service consumers using this service layer. Software services, such as those provided by the service layer 513, provide reusable, defined business functionalities, through a defined interface. For example, the interface may be software written in JAVA, C++, or suitable language providing data in Extensible Markup Language (XML) format. While illustrated as an integrated component of the computer 502, alternative implementations may illustrate the API 512 or the service layer 513 as stand-alone components in relation to other components of the computer 502 or the system 500. Moreover, any or all parts of the API 512 or the service layer 513 may be implemented as sub-modules of another software module, enterprise application, or hardware module, without departing from the scope of this disclosure.

The computer 502 includes an interface 504. Although illustrated as a single interface 504 in FIG. 5, two or more interfaces 504 may be used according to particular needs, desires, or particular implementations of the computer 502 or system 500. The interface 504 is used by the computer 502 for communicating with other systems in a distributed environment —including within the system 500 connected to the network 530 (whether illustrated or not). Generally, the interface 504 comprises logic encoded in software or hardware in a suitable combination and operable to communicate with the network 530. More specifically, the interface 504 may comprise software supporting one or more communication protocols associated with communications such that the network 530 or interface's hardware is operable to communicate physical signals within and outside of the illustrated system 500.

The computer 502 includes a processor 505. Although illustrated as a single processor 505 in FIG. 5, two or more processors may be used according to particular needs, desires, or particular implementations of the computer 502 or the system 500. Generally, the processor 505 executes instructions and manipulates data to perform the operations of the computer 502. Specifically, the processor 505 executes the functionality required for processing geophysical data.

The computer 502 also includes a memory 508 that holds data for the computer 502 or other components of the system 500. Although illustrated as a single memory 508 in FIG. 5, two or more memories may be used according to particular needs, desires, or particular implementations of the computer 502 or the system 500. While memory 508 is illustrated as an integral component of the computer 502, in alternative implementations, memory 508 can be external to the computer 502 or the system 500.

The application 507 is a software engine providing functionality according to particular needs, desires, or particular implementations of the computer 502 or the system 500, particularly with respect to functionality required for processing geophysical data. For example, application 507 can serve as one or more components or applications described in FIGS. 1-4. Further, although illustrated as a single application 507, the application 507 may be implemented as multiple applications 507, on the computer 502. In addition, although illustrated as integral to the computer 502, in alternative implementations, the application 507 can be external to the computer 502 or the system 500.

There may be any number of computers 502 associated with, or external to, the system 500 and communicating over network 530. Furthermore, the terms “client,” “user,” and other appropriate terminology may be used interchangeably, as appropriate, without departing from the scope of this disclosure. Moreover, this disclosure contemplates that many users may use one computer 502, or that one user may use multiple computers 502.

In some implementations, the described methodology can be configured to send messages, instructions, or other communications to a computer-implemented controller, database, or other computer-implemented system to dynamically initiate control of, control, or cause another computer-implemented system to perform a computer-implemented operation. For example, operations based on data, operations, outputs, or interaction with a GUI can be transmitted to cause operations associated with a computer, database, network, or other computer-based system to perform storage efficiency, data retrieval, or other operations consistent with this disclosure. In another example, interacting with any illustrated GUI can automatically result in one or more instructions transmitted from the GUI to trigger requests for data, storage of data, analysis of data, or other operations consistent with this disclosure.

In some instances, transmitted instructions can result in control, operation, modification, enhancement, or other operations with respect to a tangible, real-world piece of computing or other equipment. For example, the described GUIs can send a request to slow or speed up a computer database magnetic/optical disk drive, activate/deactivate a computing system, cause a network interface device to disable, throttle, or increase data bandwidth allowed across a network connection, or sound an audible/visual alarm (such as, a mechanical alarm/light emitting device) as a notification of a result, behavior, determination, or analysis with respect to a computing system(s) associated with the described methodology or interacting with the computing system(s) associated with the described methodology.

In some implementations, the output of the described methodology can be used to dynamically influence, direct, control, influence, or manage tangible, real-world equipment related to hydrocarbon production, analysis, and recovery or for other purposes consistent with this disclosure. For example, the response actions for severity factor can include sending a command to the field to modify a wellbore trajectory, increase/decrease speed of or stop/start a hydrocarbon drill; activate/deactivate an alarm (such as, a visual, auditory, or voice alarm), or to affect refinery or pumping operations (for example, stop, restart, accelerate, or reduce). Other examples can include alerting geo-steering and directional drilling staff when underground obstacles have been detected (such as, with a visual, auditory, or voice alarm). In some implementations, the described methodology can be integrated as part of a dynamic computer-implemented control system to control, influence, or use with any hydrocarbon-related or other tangible, real-world equipment consistent with this disclosure.

Described implementations of the subject matter can include one or more features, alone or in combination.

For example, in a first implementation, a computer-implemented method comprising: determining, by one or more hardware processors, a flow rate of an emission source in a hydrocarbon production; determining, by the one or more hardware processors, a rate of formation of one or more emission components; determining, by the one or more hardware processors, a prediction indicator tag for the emission source; and outputting, by the one or more hardware processors, the prediction indicator tag in a user interface.

The foregoing and other implementations can each, optionally, include one or more of the following features, alone or in combination:

A first aspect, combinable with the general implementation, further comprising grouping the flow rate into different categories/

A second aspect, combinable with any of the previous or subsequent aspects, where determining the rate of formation of one or more emission components includes determining hourly flaring emissions for sulfuric dioxide (SO₂), nitrogen dioxide (NO₂), carbon dioxide (CO₂), and methane (CH₄).

A third aspect, combinable with any of the previous or subsequent aspects, where the emissions for SO₂ and CO₂ are determined based on combustion stoichiometric coefficients.

A fourth aspect, combinable with any of the previous or subsequent aspects, where the emissions for NO₂ and CH₄ are determined based on American Petroleum Institute (API) Compendium emission methodologies.

A fifth aspect, combinable with any of the previous or subsequent aspects, further comprising: outputting the prediction indicator tag in user interface.

A sixth aspect, combinable with any of the previous aspects, further comprising: adjusting the hydrocarbon production based on the prediction indicator tag.

In a second implementation, a device comprising: at least one hardware processor; and a non-transitory computer-readable storage medium coupled to the at least one hardware processor and storing programming instructions for execution by the at least one hardware processor, where the programming instructions, when executed, cause the at least one hardware processor to perform operations comprising: determining a flow rate of an emission source in a hydrocarbon production; determining a rate of formation of one or more emission components; determining a prediction indicator tag for the emission source; and outputting the prediction indicator tag in a user interface.

The foregoing and other implementations can each, optionally, include one or more of the following features, alone or in combination:

A first aspect, combinable with the general implementation, the operations further comprising grouping the flow rate into different categories/

A second aspect, combinable with any of the previous or subsequent aspects, where determining the rate of formation of one or more emission components includes determining hourly flaring emissions for sulfuric dioxide (SO₂), nitrogen dioxide (NO₂), carbon dioxide (CO₂), and methane (CH₄).

A third aspect, combinable with any of the previous or subsequent aspects, where the emissions for SO₂ and CO₂ are determined based on combustion stoichiometric coefficients.

A fourth aspect, combinable with any of the previous or subsequent aspects, where the emissions for NO₂ and CH₄ are determined based on American Petroleum Institute (API) Compendium emission methodologies.

A fifth aspect, combinable with any of the previous or subsequent aspects, the operations further comprising: outputting the prediction indicator tag in user interface.

A sixth aspect, combinable with any of the previous aspects, the operations further comprising: adjusting the hydrocarbon production based on the prediction indicator tag.

In a third implementation, a non-transitory computer-readable medium storing instructions which, when executed, cause a computer to perform operations comprising: determining a flow rate of an emission source in a hydrocarbon production; determining a rate of formation of one or more emission components; determining a prediction indicator tag for the emission source; and outputting the prediction indicator tag in a user interface.

The foregoing and other implementations can each, optionally, include one or more of the following features, alone or in combination:

A first aspect, combinable with the general implementation, the operations further comprising grouping the flow rate into different categories/

A second aspect, combinable with any of the previous or subsequent aspects, where determining the rate of formation of one or more emission components includes determining hourly flaring emissions for sulfuric dioxide (SO₂), nitrogen dioxide (NO₂), carbon dioxide (CO₂), and methane (CH₄).

A third aspect, combinable with any of the previous or subsequent aspects, where the emissions for SO₂ and CO₂ are determined based on combustion stoichiometric coefficients.

A fourth aspect, combinable with any of the previous or subsequent aspects, where the emissions for NO₂ and CH₄ are determined based on American Petroleum Institute (API) Compendium emission methodologies.

A fifth aspect, combinable with any of the previous or subsequent aspects, the operations further comprising: outputting the prediction indicator tag in user interface.

A sixth aspect, combinable with any of the previous aspects, the operations further comprising: adjusting the hydrocarbon production based on the prediction indicator tag.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, that is, one or more modules of computer program instructions encoded on a tangible, non-transitory computer-storage medium for execution by, or to control the operation of, data processing apparatus. Alternatively, or in addition, the program instructions can be encoded on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include, special purpose logic circuitry, for example, a central processing unit (CPU), a FPGA (field programmable gate array), or an ASIC (application-specific integrated circuit). In some implementations, the data processing apparatus or special purpose logic circuitry may be hardware-based or software-based. The apparatus can optionally include code that creates an execution environment for computer programs, for example, code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, or IOS.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, or libraries. Conversely, the features and functionality of various components can be combined into single components, as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random-access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, for example, erasable programmable read-only memory (EPROM), electrically erasable programmable read-only memory (EEPROM), and flash memory devices; magnetic disks, for example, internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business or dynamic information, and any other appropriate information including any parameters, variables, algorithms, instructions, rules, constraints, or references thereto. Additionally, the memory may include any other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity or a multi-touch screen using capacitive or electric sensing. Other kinds of devices can be used to provide for interaction with a user as well, for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user, for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These UI elements may be related to or represent the functions of the web browser.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data may be less than 1 ms, less than 1 sec., less than 5 secs., etc. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication, for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20, and all or a portion of the Internet. The network may communicate with, for example, Internet Protocol (IP) packets, Frame Relay frames, Asynchronous Transfer Mode (ATM) cells, voice, video, data, or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and software, may interface with each other or the interface using an application programming interface (API) or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or another suitable format. The API or service layer may be an integral or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any disclosure or on the scope of what may be claimed, but rather as descriptions of features that may be specific to particular implementations of particular disclosures. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described as acting in certain combinations and even initially claimed as such, one or more features from a claimed combination can in some cases be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking and parallel processing may be advantageous.

Moreover, the separation or integration of various system modules and components in the implementations described previously should not be understood as requiring such separation or integration in all implementations, and it should be understood that the described program components and systems can generally be integrated together in a single software product or packaged into multiple software products.

Accordingly, the previous description of example implementations does not define or constrain this disclosure. Other changes, substitutions, and alterations are also possible without departing from the spirit and scope of this disclosure.

What is claimed is:

1. A computer-implemented method, comprising:
determining, by one or more hardware processors, a flow rate of an emission source in a hydrocarbon production;
determining, by the one or more hardware processors, a rate of formation of one or more emission components;
determining, by the one or more hardware processors, a prediction indicator tag for the emission source; and
outputting, by the one or more hardware processors, the prediction indicator tag in a user interface.

2. The method of claim 1, further comprising: grouping the flow rate into different categories.

3. The method of claim 1, wherein determining the rate of formation of one or more emission components includes determining hourly flaring emissions for sulfuric dioxide (SO₂), nitrogen dioxide (NO₂), carbon dioxide (CO₂), and methane (CH₄).

4. The method of claim 3, wherein the emissions for SO₂ and CO₂ are determined based on combustion stoichiometric coefficients.

5. The method of claim 3, wherein the emissions for NO₂ and CH₄ are determined based on American Petroleum Institute (API) Compendium emission methodologies.

6. The method of claim 1, further comprising: outputting the prediction indicator tag in user interface.

7. The method of claim 1, further comprising: adjusting the hydrocarbon production based on the prediction indicator tag.

8. A device, comprising:
at least one hardware processor; and
a non-transitory computer-readable storage medium coupled to the at least one hardware processor and storing programming instructions for execution by the at least one hardware processor, wherein the programming instructions, when executed, cause the at least one hardware processor to perform operations comprising:
determining a flow rate of an emission source in a hydrocarbon production;
determining a rate of formation of one or more emission components;
determining a prediction indicator tag for the emission source; and
outputting the prediction indicator tag in a user interface.

9. The device of claim 8, wherein the operations further comprise: grouping the flow rate into different categories.

10. The device of claim 8, wherein determining the rate of formation of one or more emission components includes determining hourly flaring emissions for sulfuric dioxide (SO₂), nitrogen dioxide (NO₂), carbon dioxide (CO₂), and methane (CH₄).

11. The device of claim 10, wherein the emissions for SO₂ and CO₂ are determined based on combustion stoichiometric coefficients.

12. The device of claim 10, wherein the emissions for NO₂ and CH₄ are determined based on American Petroleum Institute (API) Compendium emission methodologies.

13. The device of claim 8, wherein the operations further comprise: outputting the prediction indicator tag in user interface.

14. The device of claim 8, wherein the operations further comprise: adjusting the hydrocarbon production based on the prediction indicator tag.

15. A non-transitory computer-readable medium storing instructions which, when executed, cause a computing device to perform operations comprising:
determining a flow rate of an emission source in a hydrocarbon production;
determining a rate of formation of one or more emission components;
determining a prediction indicator tag for the emission source; and
outputting the prediction indicator tag in a user interface.

16. The non-transitory computer-readable medium of claim 15, wherein the operations further comprise: grouping the flow rate into different categories.

17. The non-transitory computer-readable medium of claim 15, wherein determining the rate of formation of one or more emission components includes determining hourly flaring emissions for sulfuric dioxide (SO₂), nitrogen dioxide (NO₂), carbon dioxide (CO₂), and methane (CH₄).

18. The non-transitory computer-readable medium of claim 17, wherein the emissions for SO₂ and CO₂ are determined based on combustion stoichiometric coefficients.

19. The non-transitory computer-readable medium of claim 17, wherein the emissions for NO₂ and CH₄ are determined based on American Petroleum Institute (API) Compendium emission methodologies.

20. The non-transitory computer-readable medium of claim 15, wherein the operations further comprise: outputting the prediction indicator tag in user interface.
